(19) United States
(12) Patent Application Publication
(10) Pub. No.: US 2013/0019595 A1
(43) Pub. Date: Jan. 24, 2013

(54) CONTROL APPARATUS AND CONTROL METHOD FOR STIRLING ENGINE

(71) Applicants: Akio Yoshimatsu, Gotenba-shi (JP); Manabu Tateno, Shizuoka-ken (JP); Masaaki Katayama, Susono-shi (JP)

(72) Inventors: Akio Yoshimatsu, Gotenba-shi (JP); Manabu Tateno, Shizuoka-ken (JP); Masaaki Katayama, Susono-shi (JP)

(21) Appl. No.: 13/549,560

(22) Filed: Jul. 16, 2012

(30) Foreign Application Priority Data
Jul. 19, 2011 (JP) 2011-158264

(51) Int. Cl. F02G 1/045

(52) U.S. Cl. 60/616; 60/646

(57) ABSTRACT

A control apparatus for a Stirling engine that uses exhaust gas of an internal combustion engine as a high-temperature heat source and is provided with a starter that drives an output shaft, includes a control unit that drives the starter in starting up the Stirling engine, stops driving the starter when a rotational speed of the Stirling engine reaches a target rotational speed, and then drives the starter again when the rotational speed of the Stirling engine becomes lower than a predetermined value.

### INCORPORATION BY REFERENCE

The disclosure of Japanese Patent Application No. 2011-158264 filed on Jul. 19, 2011 including the specification, drawings and abstract is incorporated herein by reference in its entirety.

### BACKGROUND OF THE INVENTION

1. Field of the Invention

The invention relates to a control apparatus and a control method for a Stirling engine.

2. Description of Related Art

An art associated with the startup of a Stirling engine is disclosed in, for example, Japanese Patent Application Publication No. 6-264817 (JP-6-264817 A) and Japanese Patent Application Publication No. 7-158508 (JP-7-158508 A). It is disclosed in Japanese Patent Application Publication No. 6-264817 (JP-6-264817 A) that a starter is preliminarily operated for a predetermined time after the temperature of a surface of a heater tube of a Stirling engine rises to a predetermined temperature. In addition, for example, each of Japanese Patent Application Publication No. 2009-47138 (JP-2009-47138 A) and Japanese Patent Application Publication No. 2009-85087 (JP-2009-85087 A) discloses an art considered to be related to the invention in that a Stirling engine that uses exhaust gas of an internal combustion engine as a high-temperature heat source is disclosed.

In the case where exhaust gas of the internal combustion engine is used as a high-temperature heat source, due to the configuration of recovering exhaust heat of the internal combustion engine, the operation state of the internal combustion engine is not changed in principle to control the amount of heat input to the Stirling engine. Thus, in this case, when the starter is driven for a predetermined time in starting up the Stirling engine, the starter may continue to be driven more than necessary, because the amount of heat input to the Stirling engine is not managed in particular. As a result, excess energy is consumed, and hence the efficiency of recovering energy may deteriorate.

### SUMMARY OF THE INVENTION

The invention provides a control apparatus and a control method for a Stirling engine, which reduce the amount of energy needed for startup in starting up the Stirling engine that uses exhaust gas of an internal combustion engine as a high-temperature heat source.

A first aspect of the invention relates to a control apparatus for a Stirling engine that uses exhaust gas of an internal combustion engine as a high-temperature heat source and is provided with a starter that drives an output shaft. The control apparatus includes a control unit that drives the starter in starting up the Stirling engine, stops driving the starter when a rotational speed of the Stirling engine reaches a target rotational speed, and then drives the starter again when the rotational speed of the Stirling engine becomes lower than a predetermined value.

In the control apparatus according to the above-described aspect of the invention, the control unit may adjust the driving of the starter in accordance with a degree of change in a temperature of a working fluid for the Stirling engine.

The control apparatus according to the above-described aspect of the invention may further include a first estimation unit that estimates a generation rotational speed of the Stirling engine on a basis of an operation state of the internal combustion engine, and a setting unit that sets the target rotational speed so that the target rotational speed is equal to or lower than the generation rotational speed.

The control apparatus according to the above-described aspect of the invention may further include a second estimation unit that estimates an accumulated value of an exhaust gas energy of the internal combustion engine. In starting up the Stirling engine, the control unit may drive the starter when the accumulated value estimated by the second estimation unit is larger than a predetermined value and it is estimated that a minimum output of the Stirling engine that is needed for autonomous operation will be obtained if the starter is driven.

The control apparatus according to the above-described aspect of the invention may further include a third estimation unit that estimates an output of the Stirling engine on a basis of an operation state of the internal combustion engine, and the control unit may stop driving the starter when the output estimated by the third estimation unit is smaller than a predetermined threshold during deceleration of a vehicle that includes the internal combustion engine.

A second aspect of the invention relates to a control method for a Stirling engine that uses exhaust gas of an internal combustion engine as a high-temperature heat source and is provided with a starter that drives an output shaft. The control method includes driving the starter in starting up the Stirling engine; determining whether or not a rotational speed of the Stirling engine has reached a target rotational speed; stopping driving the starter when the rotational speed of the Stirling engine has reached the target rotational speed; determining whether or not the rotational speed of the Stirling engine has become lower than a predetermined value, after stopping driving the starter; and driving the starter again when the rotational speed of the Stirling engine has become lower than the predetermined value, after stopping driving the starter.

According to each of the foregoing aspects of the invention, the amount of energy needed for startup can be reduced in starting up the Stirling engine that uses exhaust gas of the internal combustion engine as a high-temperature heat source.

### BRIEF DESCRIPTION OF THE DRAWINGS

The features, advantages, and technical and industrial significance of this invention will be described in the following detailed description of an example embodiment of the invention with reference to the accompanying drawings, in which like numerals denote like elements, and wherein:

FIG. 1 is an overall view of components including a Stirling engine according to an embodiment of the invention;

FIG. 2 is a view showing a first control operation according to the embodiment of the invention in the form of a flowchart;

FIG. 3 is a view showing changes in rotational speed during startup control in the embodiment of the invention;

FIG. 4 is a view showing a relationship between a degree of change in temperature of a working fluid and a degree of rise in rotational speed in the embodiment of the invention;

FIG. 5 is a view showing a difference in the degree of rise in rotational speed that corresponds to the degree of change in temperature of the working fluid in the embodiment of the invention;

FIG. 6 is a view showing a second control operation according to the embodiment of the invention in the form of a flowchart;

FIG. 7 is a view showing a maximum output generation rotational speed of the Stirling engine that corresponds to an operation state of an internal combustion engine in the embodiment of the invention;

FIG. 8 is a view showing a third control operation according to the embodiment of the invention in the form of a flowchart;

FIG. 9 is a view showing an output of the Stirling engine that corresponds to an operation state of the internal combustion engine in the embodiment of the invention;

FIG. 10 is a view showing a fourth control operation according to the embodiment of the invention in the form of a flowchart; and

FIG. 11 is a view showing a fifth control operation according to the embodiment of the invention in the form of a flowchart.

### DETAILED DESCRIPTION OF EMBODIMENT

An embodiment of the invention will be described using the drawings.

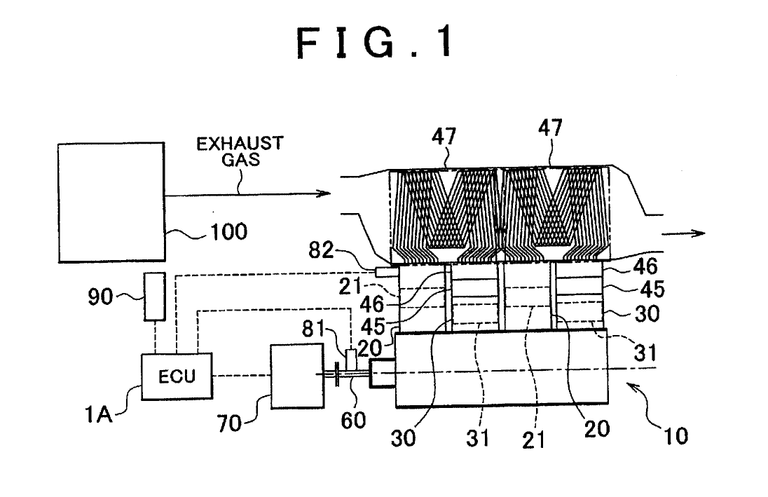

FIG. 1 is an overall view of components including a Stirling engine 10. The components shown in FIG. 1 are mounted on a vehicle (not shown). The Stirling engine 10 is an α-type Stirling engine. The Stirling engine 10 includes high temperature-side cylinders 20 and low temperature-side cylinders 30 that are arranged in series to extend in parallel with one another. The Stirling engine 10 is configured to include a plurality of sets (two sets in this case) of the cylinders 20 and 30 for an output shaft 60. The Stirling engine 10 may be configured to include one set of the cylinders 20 and 30 for the common output shaft 60.

The high temperature-side cylinders 20 include expansion pistons 21 respectively, and the low temperature-side cylinders 30 include compression pistons 31 respectively. There is a phase difference so that each of the compression pistons 31 moves with a delay of a crank angle of about 90° with respect to a corresponding one of the expansion pistons 21. Reciprocating movements of the pistons 21 and 31 are converted into rotational movements by the output shaft 60.

An upper space in each of the high temperature-side cylinders 20 constitutes an expansion space. A working fluid heated by a heater 47 flows into the expansion space. In the heater 47, heat is exchanged between the flowing working fluid and exhaust gas of an internal combustion engine 100. The working fluid is thus heated by thermal energy recovered from exhaust gas. More specifically, the heater 47 is a multitubular heat exchanger. Exhaust gas of the internal combustion engine 100 is used as a high-temperature heat source of the Stirling engine 10.

An upper space in each of the low temperature-side cylinders 30 constitutes a compression space. The working fluid cooled by a cooler 45 flows into the compression space. A regenerator 46 gives/receives heat to/from the working fluid that flows in a reciprocating manner between the expansion space and the compression space. More specifically, the regenerator 46 receives heat from the working fluid when the working fluid flows from the expansion space to the compression space, and releases accumulated heat to the working fluid when the working fluid flows from the compression space to the expansion space. Air is adopted as the working fluid. However, the working fluid is not limited to air. For example, a gas such as He, H₂, N₂, or the like can be adopted as the working fluid.

Next, the operation of the Stirling engine 10 will be described. When the heater 47 heats the working fluid, the working fluid expands to press down the expansion piston 21. Then, the output shaft 60 thus rotates. Subsequently, when the expansion piston 21 moves upward, the working fluid passes through the heater 47 to be transported to the regenerator 46. Then, the working fluid discharges heat in the regenerator 46, and flows to the cooler 45. The working fluid cooled by the cooler 45 flows into the compression space, and further, is compressed as the compression piston 31 moves upward. The temperature of the working fluid thus compressed rises while the working fluid takes heat from the regenerator 46. Then, the working fluid flows into the heater 47. Then, the working fluid is heated again, and expands. The Stirling engine 10 operates through the reciprocating flow of this working fluid.

The output shaft 60 is provided with a starter 70. The starter 70 drives the output shaft 60. The Stirling engine 10 is thus started. The output shaft 60 is provided with a rotational speed sensor 81 for detecting a rotational speed S-NE of the Stirling engine 10. The Stirling engine 10 is provided with a temperature sensor 82 for detecting a temperature of the working fluid. The temperature sensor 82 may be so provided as to detect, for example, a temperature of the working fluid in the expansion space.

An ECU 1A is an electronic control unit that may be regarded as a control apparatus for the Stirling engine. The ECU 1A includes a microcomputer that includes a CPU, a ROM, a RAM, and the like. Various sensor/switch components such as a rotational speed sensor 81, a temperature sensor 82, and the like are electrically connected to the ECU 1A. Further, the starter 70 is electrically connected, as a control target, to the ECU 1A.

Furthermore, a sensor group 90 for detecting an operation state of the vehicle including an operation state of the internal combustion engine 100 is electrically connected to the ECU 1A. The sensor group 90 includes, for example, an airflow meter that measures an intake air amount of the internal combustion engine 100, a throttle opening degree sensor for detecting an opening degree of a throttle valve that adjusts an intake air amount of the internal combustion engine 100, a crank angle sensor that is used to detect a rotational speed of the internal combustion engine 100, an exhaust gas temperature sensor for detecting a temperature of exhaust gas that exchanges heat with the heater 47, and a vehicle speed sensor for detecting a vehicle speed Spd.

The ROM stores a program in which various processings performed by the CPU are described, map data, and the like. The CPU performs the processings on the basis of the program stored in the ROM, while utilizing a temporary storage region of the RAM as needed, so that various functional units, for example, a control unit shown below, are realized in the ECU 1A.

The control unit performs startup control. That is, the control unit drives the starter 70 in starting up the Stirling engine 10, stops driving the starter 70 when the rotational speed S-NE reaches a target rotational speed, and then drives the starter 70 again when the rotational speed S-NE becomes lower than a predetermined value Low. After stopping driving the starter 70, the control unit ends startup control when a rotational speed change amount ΔS-NE is equal to or larger than zero.

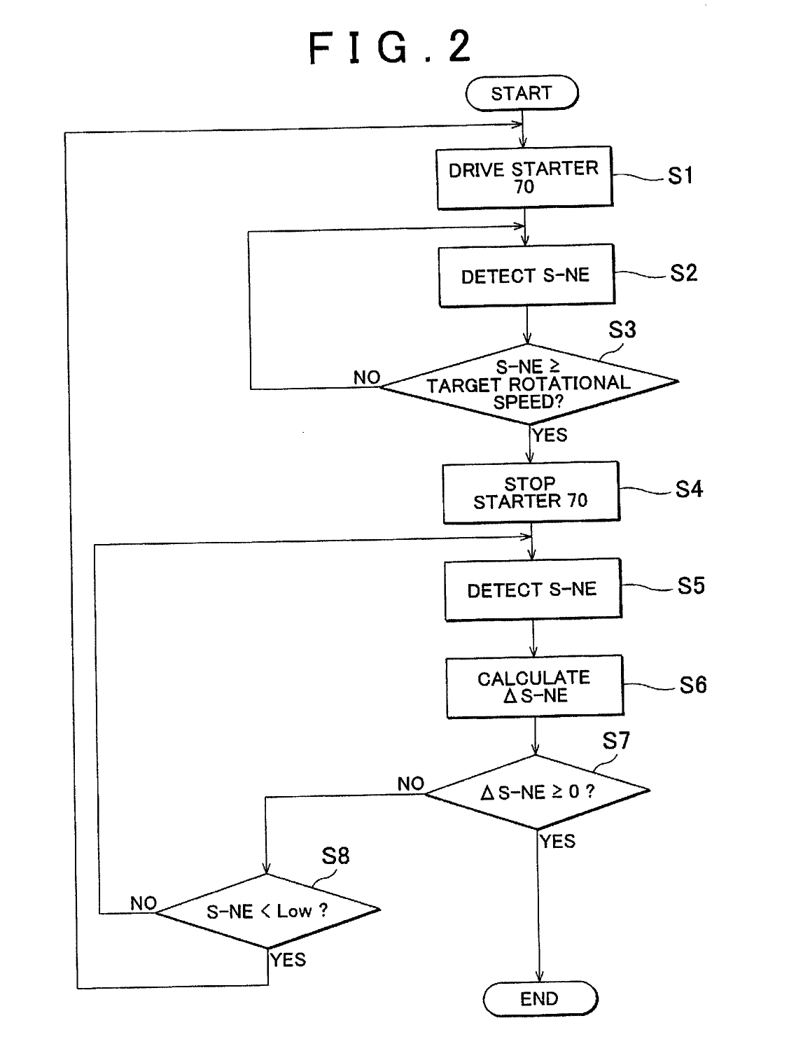

Next, the operation of the ECU 1A as a first control operation will be described using a flowchart shown in FIG. 2. This flowchart can be started when a predetermined startup start condition is fulfilled, in starting up the Stirling engine 10. The ECU 1A drives the starter 70 (step S1). Subsequently, the ECU 1A detects the rotational speed S-NE (step S2), and determines whether or not the detected rotational speed S-NE is equal to or higher than a target rotational speed (step S3). When a negative determination is made in step S3, a return to step S2 is made.

On the other hand, when an affirmative determination is made in step S3, it is determined that the rotational speed S-NE has reached the target rotational speed. Thus, when an affirmative determination is made in step S3, the ECU 1A stops driving the starter 70 (step S4). Then, after that, the ECU 1A detects the rotational speed S-NE (step S5), and calculates the rotational speed change amount ΔS-NE (step S6). In calculating the rotational speed change amount ΔS-NE, the ECU 1A can detect the rotational speed S-NE twice in step S5.

Subsequently, the ECU 1A determines whether or not the calculated rotational speed change amount ΔS-NE is equal to or larger than zero (step S7). When the rotational speed change amount ΔS-NE is equal to or larger than zero, it is determined that the Stirling engine 10 can be autonomously operated. Thus, when an affirmative determination is made in step S7, the ECU 1A ends the control indicated by this flowchart. That is, startup control of the Stirling engine 10 ends.

When a negative determination is made in step S7, the ECU 1A determines whether or not the rotational speed S-NE has become lower than a predetermined value Low (step S8). When a negative determination is made, a return to step S5 is made. On the other hand, when an affirmative determination is made, a return to step S1 is made. Thus, the starter 70 is driven again when the rotational speed S-NE becomes lower than the predetermined value Low after the driving of the starter 70 has been stopped.

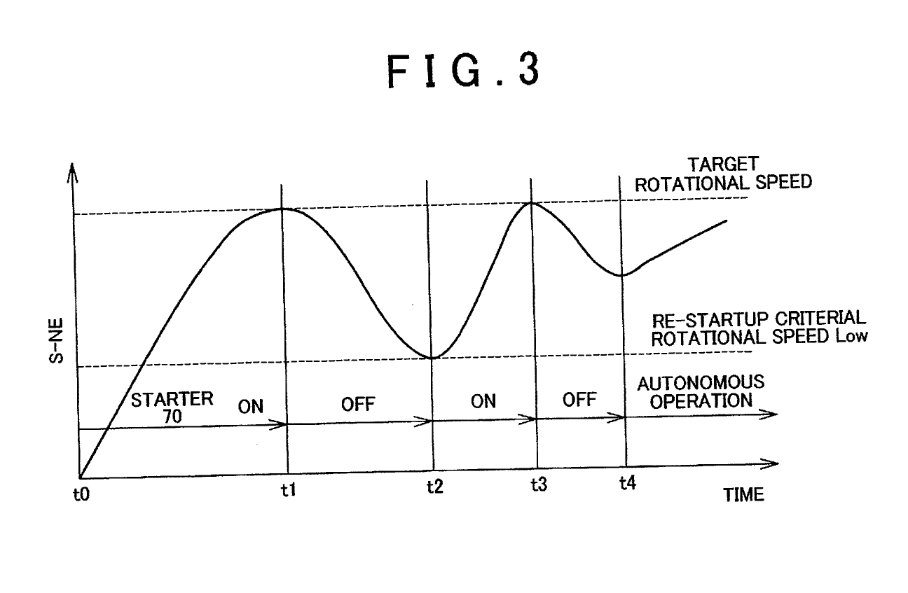

FIG. 3 is a view showing changes in the rotational speed S-NE during startup control. FIG. 3 shows an example of changes in the rotational speed S-NE that corresponds to the flowchart shown in FIG. 2. In FIG. 3, the driving of the starter 70 is started at a time t0. Thus, the rotational speed S-NE gradually rises from the time t0. Then, when the rotational speed S-NE reaches the target rotational speed at a time t1, the driving of the starter 70 is stopped. Thus, the rotational speed S-NE gradually decreases from the time t1. In this case, the Stirling engine 10 is being decelerated, but the working fluid is heated by exhaust gas. Accordingly, the warm-up itself that is needed to start up the Stirling engine 10 is carried out.

When the rotational speed S-NE decreases and becomes lower than the predetermined value Low that is a re-startup criterial rotational speed at a time t2, the driving of the starter 70 is started again. Then, after that, when the rotational speed S-NE rises again and reaches the target rotational speed at a time t3, the driving of the starter 70 is stopped. The rotational speed S-NE gradually decreases from the time t3, but the Stirling engine 10 becomes autonomously operable at a time t4 as a result of the heating of the working fluid. Thus, the rotational speed S-NE rises from the time t4 as a result of the start of autonomous operation of the Stirling engine 10.

Next, the advantageous effects of the ECU 1A will be described. In starting up the Stirling engine 10, the ECU 1A drives the starter 70. When the rotational speed S-NE reaches the target rotational speed, the ECU 1A stops driving the starter 70. Then, after that, when the rotational speed S-NE becomes lower than the predetermined value Low, the ECU 1A drives the starter 70 again. That is, the ECU 1A stops driving the starter 70 when the Stirling engine 10 becomes autonomously operable, and drives the starter 70 again when the Stirling engine 10 cannot be autonomously operated.

Thus, when the Stirling engine 10 starts autonomous operation and the starter 70 is not driven again after the ECU 1A stops driving the starter 70, the ECU 1A can suitably reduce the electric power for driving the starter 70. Then, the amount of energy that is needed to start up the Stirling engine 10 can thus be reduced. Further, even in the case where the Stirling engine 10 does not start autonomous operation, the starter 70 that has been driven again is stopped when the rotational speed S-NE reaches the target rotational speed. Thus, it is possible to start up the Stirling engine 10 while reducing the amount of energy that is needed to start up the Stirling engine 10.

An ECU 1B according to this embodiment of the invention is substantially identical to the ECU 1A except that a control unit of the ECU 1B is further realized as will be described below. Thus, the ECU 1B is not shown in the drawings. In the ECU 1B, the control unit further adjusts the driving of the starter 70 in accordance with a temperature change degree ΔTg of the working fluid of the Stirling engine 10 (i.e., the degree ΔTg of change in the temperature of the working fluid of the Stirling engine 10). More specifically, the control unit adjusts the driving of the starter 70 such that a rotational speed rise degree ΔS-NEa, which is a degree of rise in the rotational speed S-NE, increases as the temperature change degree ΔTg of the working fluid increases.

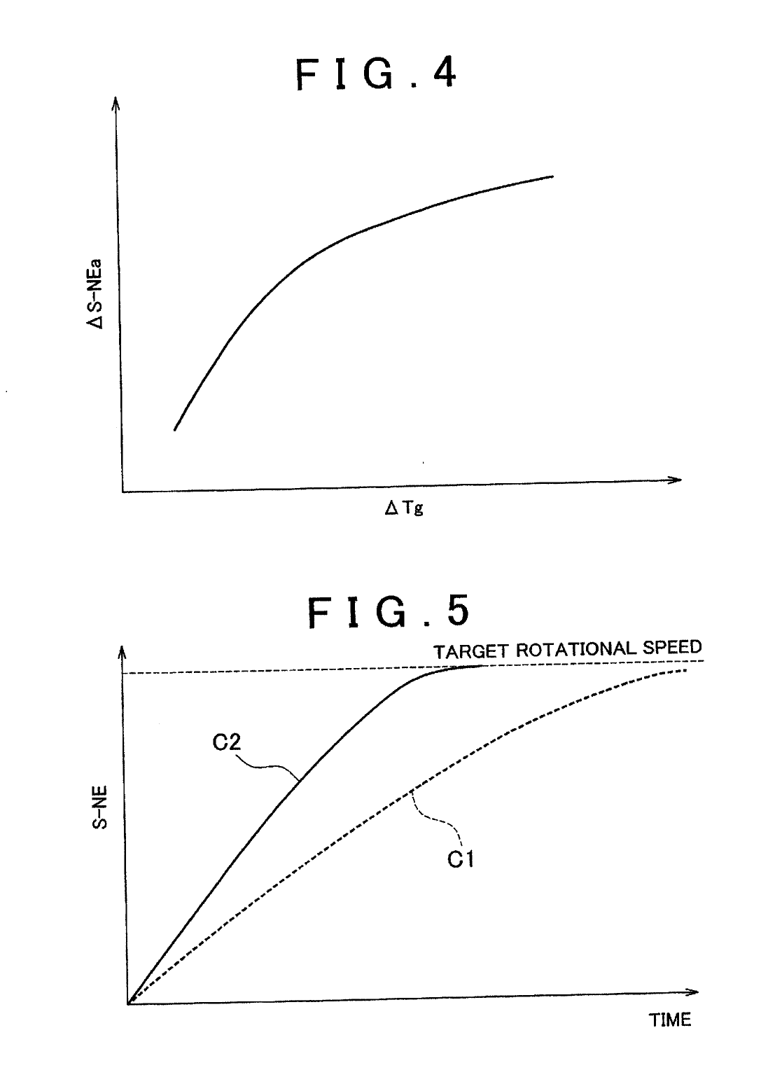

FIG. 4 is a view showing a relationship between the temperature change degree ΔTg of the working fluid and the rotational speed rise degree ΔS-NEa. As shown in FIG. 4, the rotational speed rise degree ΔS-NEa is set to increase as the temperature change degree ΔTg of the working fluid increases. In other words, the rotational speed rise degree of the starter 70 (i.e., the degree of rise in the rotational speed of the starter 70) is set to increase as the temperature change degree ΔTg of the working fluid increases.

FIG. 5 is a view showing a difference in the rotational speed rise degree ΔS-NEa that corresponds to the temperature change degree ΔTg of the working fluid. A curve C1 indicates a case where the temperature change degree ΔTg of the working fluid is relatively small, and a curve C2 indicates a case where the temperature change degree ΔTg of the working fluid is relatively large. The driving of the starter 70 is adjusted such that the rotational speed rise degree ΔS-NEa increases as the temperature change degree ΔTg of the working fluid increases. As a result, the time until the rotational speed S-NE reaches the target rotational speed in the case indicated by the curve C2 is shorter than the time until the rotational speed S-NE reaches the target rotational speed in the case indicated by the curve C1.

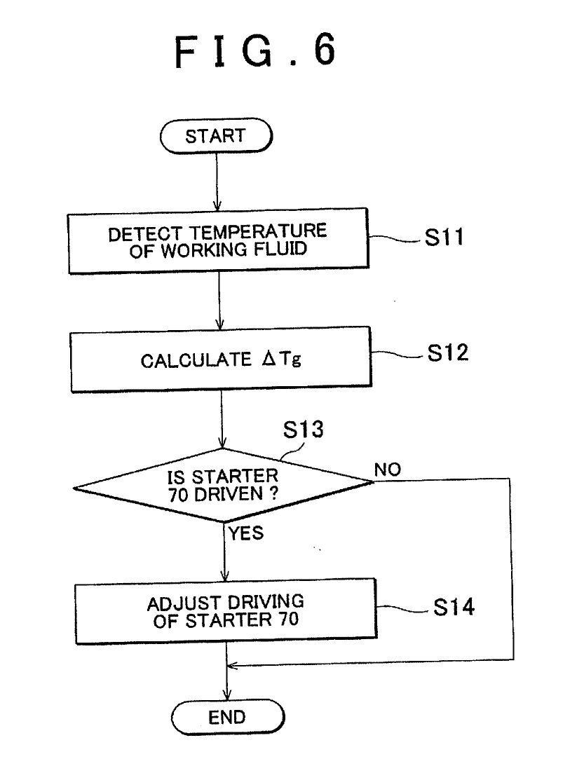

Next, a second control operation as the operation of the ECU 1B will be described using a flowchart shown in FIG. 6. The control indicated by the flowchart of FIG. 6 can be performed in parallel with the control indicated by the flowchart of FIG. 2. The ECU 1B detects a temperature of the working fluid (step S11), and calculates the temperature change degree ΔTg of the working fluid (step S12). In calculating the temperature change degree ΔTg of the working fluid, the ECU 1B can detect the temperature of the working fluid twice in step S11. Subsequently, the ECU 1B determines whether or not the starter 70 is driven (step S13). When a negative determination is made, the ECU 1B ends the control indicated by this flowchart. When an affirmative determination is made, the ECU 1B adjusts the driving of the starter 70 in accordance with the calculated temperature change degree ΔTg (step S14).

Next, the advantageous effects of the ECU 1B will be described. The ECU 1B adjusts the driving of the starter 70 in accordance with the temperature change degree ΔTg of the working fluid. More specifically, the ECU 1B adjusts the driving of the starter 70 such that the rotational speed rise degree ΔS-NEa increases as the temperature change degree ΔTg of the working fluid increases. That is, the ECU 1B determines that warm-up proceeds more readily as the temperature change degree ΔTg of the working fluid increases, and causes the rotational speed S-NE to reach the target rotational speed more quickly as the temperature change degree ΔTg of the working fluid increases. Thus, the ECU 1B can shorten the time that is needed to start autonomous operation of the Stirling engine 10. As a result, the recovery of exhaust heat of the internal combustion engine 100 can be started at an earlier timing.

An ECU 1C according to this embodiment of the invention is substantially identical to the ECU 1B except that a first estimation unit described below and a setting unit described below are further realized. Thus, the ECU 1C is not shown in the drawings. For example, the ECU 1A may be changed in a similar manner. The first estimation unit estimates a generation rotational speed of the Stirling engine 10 on the basis of an operation state of the internal combustion engine 100. More specifically, the operation state of the internal combustion engine 100 is a rotational speed of the internal combustion engine 100 and a load of the internal combustion engine 100. The setting unit sets the target rotational speed so that the target rotational speed is equal to or lower than the generation rotational speed. More specifically, the setting unit can set the target rotational speed in accordance with the generation rotational speed.

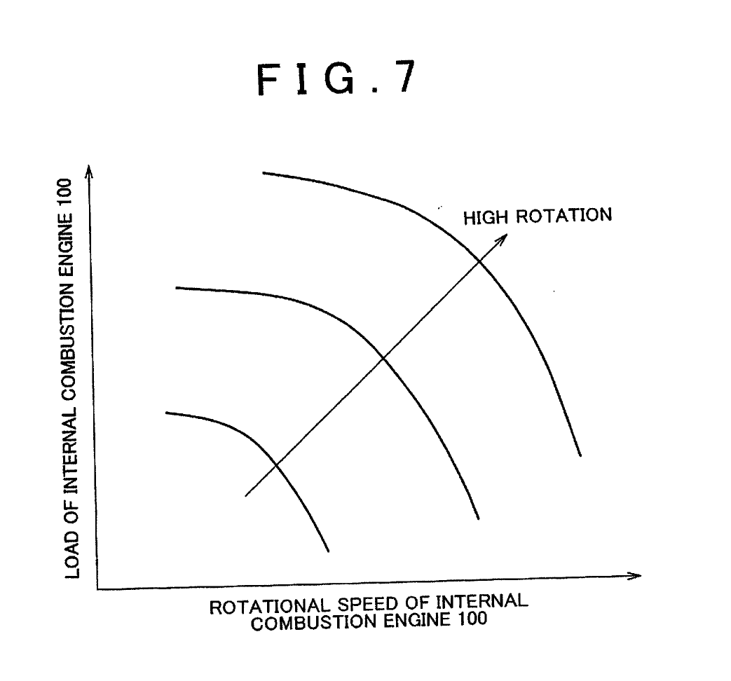

FIG. 7 is a view showing a maximum output generation rotational speed of the Stirling engine 10 that corresponds to the operation state of the internal combustion engine 100. FIG. 7 shows the maximum output generation rotational speed of the Stirling engine 10 (i.e., the rotational speed of the Stirling engine 10 at which the maximum output is generated) in the case where the internal combustion engine 100 is steadily operated. As shown in FIG. 7, the maximum output generation rotational speed rises as the rotational speed of the internal combustion engine 100 rises. Further, the maximum output generation rotational speed rises as the load of the internal combustion engine 100 increases.

More specifically, the generation rotational speed estimated by the first estimation unit is the maximum output generation rotational speed of the Stirling engine 10 in the case where the internal combustion engine 100 is steadily operated. The ECU 1C includes map data in which a relationship shown in FIG. 7 is preset. More specifically, the first estimation unit detects the operation state of the internal combustion engine 100, and reads the maximum output generation rotational speed corresponding to the detected operation state from the map data. Thus, the first estimation unit estimates the generation rotational speed of the Stirling engine 10 on the basis of the operation state of the internal combustion engine 100.

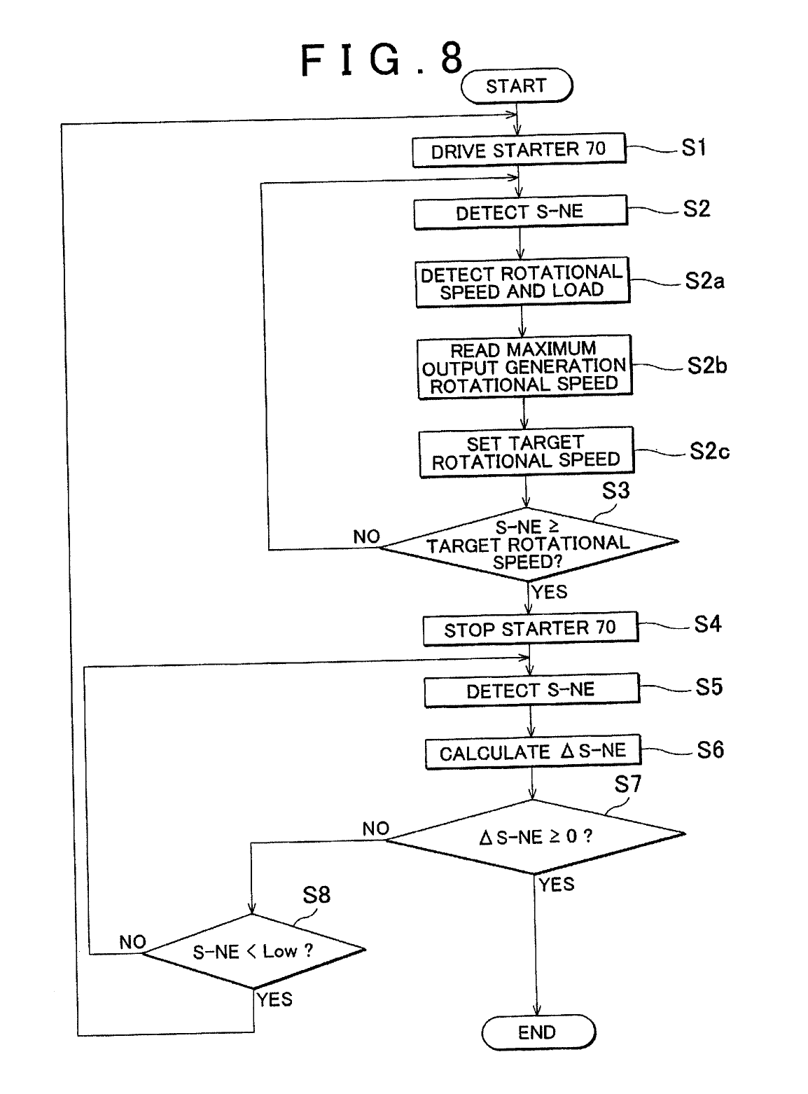

Next, a third control operation as the operation of the ECU 1C will be described using a flowchart shown in FIG. 8. It should be noted that the flowchart shown in FIG. 8 is identical to the flowchart shown in FIG. 2 except that steps S2a, S2b, and S2c are added between steps S2 and S3. Thus, those steps will now be described in particular. The ECU 1C detects the rotational speed of the internal combustion engine 100 and the load of the internal combustion engine 100 (step S2a). Subsequently, the ECU 1C reads the maximum output generation rotational speed on the basis of the detected rotational speed and the detected load (step S2b). Then, the ECU 1C sets the target rotational speed so that the target rotational speed is equal to or lower than the maximum output generation rotational speed thus read (step S2c).

Next, the advantageous effects of the ECU 1C will be described. The ECU 1C estimates the generation rotational speed of the Stirling engine 10 in accordance with the operation state of the internal combustion engine 100, and sets the target rotational speed so that the target rotational speed is equal to or lower than the generation rotational speed. Thus, in cranking the Stirling engine 10 by the starter 70, the ECU 1C can set the target rotational speed in consideration of the efficiency of recovering exhaust heat. More specifically, the ECU 1C can set the target rotational speed such that the efficiency of recovering exhaust heat becomes the maximum value, by setting the target rotational speed in accordance with the generation rotational speed.

Thus, the ECU 1C can enhance the efficiency of recovering exhaust heat when the Stirling engine 10 starts autonomous operation immediately after the driving of the starter 70 is stopped. Further, even in the case where the Stirling engine 10 cannot immediately start autonomous operation, the ECU 1C can enhance the possibility of autonomous operation being started during deceleration of the Stirling engine 10.

An ECU 1D according to this embodiment of the invention is substantially identical to the ECU 1C except that a second estimation unit described below and a third estimation unit described below are further realized, and that the control unit is further, realized as will be described below. Thus, the ECU 1D is not shown in the drawings. For example, the ECU 1A and the ECU 1B may be changed in a similar manner.

The second estimation unit estimates an accumulated value E_{gasu} as an accumulated value of an exhaust gas energy E_{gas} of the internal combustion engine 100. More specifically, the second estimation unit continues to calculate a product of an intake air amount of the internal combustion engine 100 and a temperature of exhaust gas since the startup of the internal combustion engine 100, and calculates an accumulated value of the calculated product to estimate the accumulated value E_{gasu}. In estimating the accumulated value E_{gasu}, for example, an amount of exhaust gas may be used instead of an intake air amount of the internal combustion engine 100.

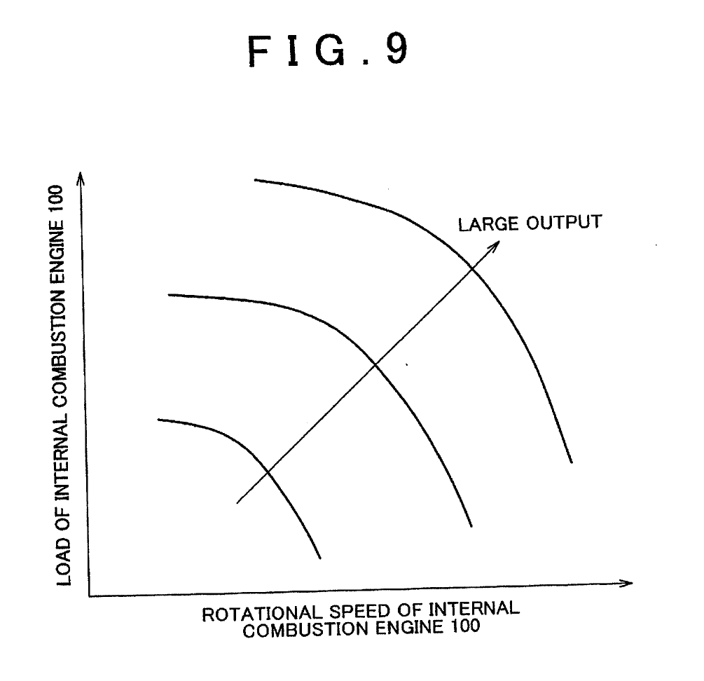

The third estimation unit estimates an output S-Pwr of the Stirling engine 10 on the basis of the operation state of the internal combustion engine 100. FIG. 9 is a view showing the output S-Pwr that corresponds to the operation state of the internal combustion engine 100. FIG. 9 shows the output S-Pwr in the case where the internal combustion engine 100 is steadily operated. As shown in FIG. 9, the output S-Pwr increases as the rotational speed of the internal combustion engine 100 rises. Further, the output S-Pwr increases as the load of the internal combustion engine 100 increases. The ECU 1D includes map data in which a relationship shown in FIG. 9 is preset. Thus, more specifically, the third estimation unit detects the operation state of the internal combustion engine 100, and reads from the map data the output S-Pwr that corresponds to the detected operation state. Thus, the third estimation unit estimates the output S-Pwr on the basis of the operation state of the internal combustion engine 100.

In starting up the Stirling engine 10, the control unit drives the starter 70 when the accumulated value E_{gasu} estimated by the second estimation unit is larger than a predetermined value E and it is estimated that a minimum output of the Stirling engine 10 that is needed for autonomous operation will be obtained if the starter 70 is driven (i.e., the minimum output of the Stifling engine 10 that is needed for autonomous operation is estimated to be obtained if the starter 70 is driven). More specifically, in the case where the output S-Pwr estimated by the third estimation unit is larger than a predetermined value P (more specifically, equal to or larger than the predetermined value P in this case), it is estimated that the minimum output of the Stirling engine 10 that is needed for autonomous operation will be obtained if the starter 70 is driven.

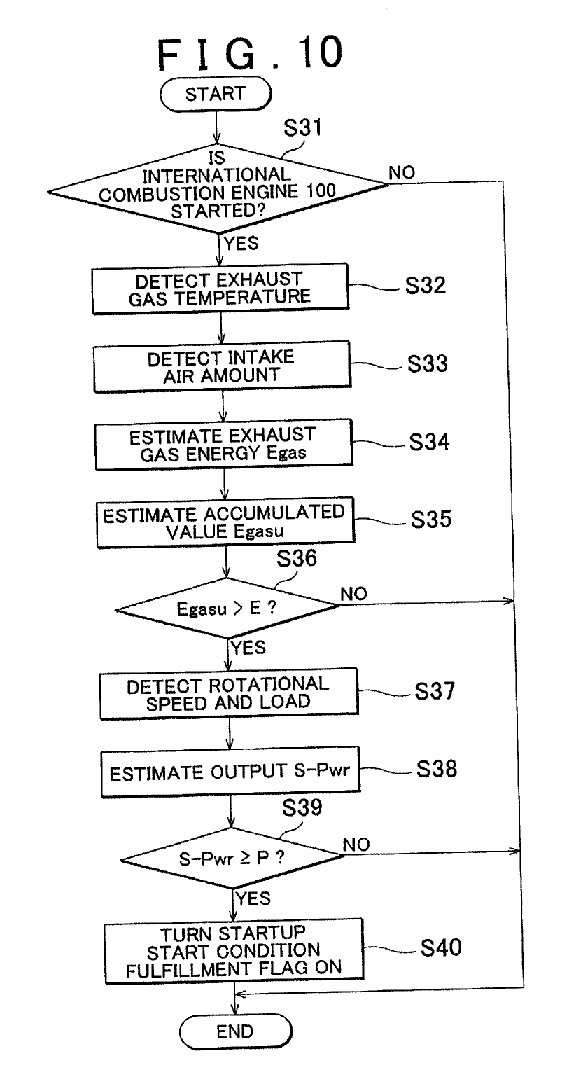

Next, the operation of the ECU 1D as a fourth control operation will be described using a flowchart shown in FIG. 10. The control indicated by the flowchart of FIG. 10 can be performed when the control indicated by the flowchart of FIG. 8 is performed. The ECU 1D determines whether or not the internal combustion engine 100 has been started up (step S31). When a negative determination is made, the ECU 1D ends the control indicated by this flowchart. When an affirmative determination is made, the ECU 1D detects the temperature of exhaust gas (step S32), and detects an intake air amount (step S33). Then, the ECU 1D estimates the exhaust gas energy E_{gas} on the basis of the detected exhaust gas temperature and the detected intake air amount (step S34), and estimates the accumulated value E_{gasu} (step S35).

Subsequently, the ECU 1D determines whether or not the calculated accumulated value E_{gasu} is larger than the predetermined value E (step S36). When a negative determination is made, the ECU 1D ends the control indicated by this flowchart. When an affirmative determination is made, the ECU 1D detects the rotational speed of the internal combustion engine 100 and the load of the internal combustion engine 100 (step S37), and estimates the output S-Pwr (step S38). Then, the ECU 1D determines whether or not the output S-Pwr is equal to or larger than the predetermined value P (step S39).

When a negative determination is made in step S39, it is determined that the minimum output needed for autonomous operation is not obtained. Thus, in this case, the ECU 1D ends the control indicated by this flowchart. When an affirmative determination is made in step S39, the ECU 1D turns ON a flag indicating that a startup start condition for the Stirling engine 10 is fulfilled (step S40). Then, the ECU 1D starts the control indicated by the flowchart of FIG. 8 on the basis of the flag, thereby driving the starter 70.

Next, the advantageous effects of the ECU 1D will be described. In starting up the Stirling engine 10, the ECU 1D estimates the accumulated value E_{gasu}, and drives the starter 70 when the accumulated value E_{gasu} thus estimated is larger than the predetermined value E and it is estimated that the minimum output of the Stirling engine 10 that is needed for autonomous operation will be obtained if the starter 70 is driven. In other words, the ECU 1D drives the starter 70 when a startup start condition is fulfilled, that is, when warming-up of the Stirling engine 10 has proceeded and the Stirling engine 10 is in an autonomously operable state.

Thus, the ECU 1D can reliably start up the Stirling engine 10 in a short time. Further, since the accumulated value E_{gasu} and the output S-Pwr can be estimated on the basis of outputs of an airflow meter, a crank angle sensor, and an exhaust gas temperature sensor that are generally employed for the internal combustion engine 100, no new sensor is required in particular. Thus, the ECU 1D can be advantageously configured in terms of cost as well.

An ECU 1E according to this embodiment of the invention is substantially identical to the ECU 1D except that the third estimation unit and the control unit are further realized as will be described later. Thus, the ECU 1E is not shown in the drawings. For example, the ECU 1A, the ECU 1B, and the ECU 1C may be changed in a similar manner. In the ECU 1E, the third estimation unit further estimates the output S-Pwr on the basis of the operation state of the internal combustion engine 100 during deceleration of the vehicle. In addition, the control unit further stops driving the starter 70 when the output S-Pwr estimated by the third estimation unit is smaller than a threshold α as a predetermined threshold. The threshold α is set as a value for determining whether or not the Stirling engine 10 can be autonomously operated.

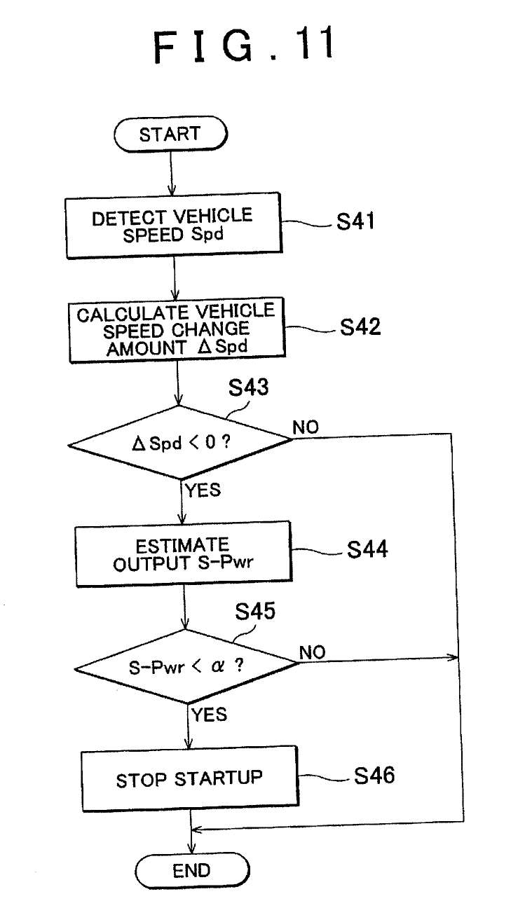

Next, the operation of the ECU 1E as a fifth control operation will be described using a flowchart shown in FIG. 11. The control indicated by the flowchart of FIG. 11 can be performed in parallel with the control indicated by the flowchart of FIG. 8. The ECU 1E detects the vehicle speed Spd (step S41), and calculates a vehicle speed change amount ΔSpd (step S42). In calculating the vehicle speed change amount ΔSpd, the ECU 1E can detect the vehicle speed Spd twice in step S41.

Subsequently, the ECU 1E determines whether or not the vehicle speed change amount ΔSpd is smaller than zero (step S43). When a negative determination is made, it is determined that the vehicle steadily runs or is accelerated. Then in this case, the ECU 1E ends the control indicated by this flowchart. On the other hand, when an affirmative determination is made in step S43, it is determined that the vehicle is decelerated. Then in this case, the ECU 1E estimates the output S-Pwr (step S44), and determines whether or not the estimated output S-Pwr is smaller than the threshold α (step S45).

When a negative determination is made in step S45, it is determined that the exhaust gas energy E_{gas} has not decreased to such an extent that the Stirling engine 10 cannot be autonomously operated. Then in this case, the ECU 1E ends the control indicated by this flowchart. On the other hand, when an affirmative determination is made in step S45, it is determined that the exhaust gas energy E_{gas} has decreased to such an extent that the Stirling engine 10 cannot be autonomously operated. Thus, in this case, the ECU 1E stops the startup control of the Stirling engine 10 (step S46).

Next, the advantageous effects of the ECU 1E will be described. The ECU 1E estimates the output S-Pwr on the basis of the operation state of the internal combustion engine 100 during deceleration of the vehicle, and stops driving the starter 70 when the estimated output S-Pwr is smaller than the threshold α. That is, in starting up the Stirling engine 10, the ECU 1E stops driving the Stirling engine 10 in the case where the exhaust gas energy E_{gas} becomes insufficient. Thus, the ECU 1E can further restrain energy from being wastefully consumed through cranking.

Although the embodiment of the invention has been described in detail, the invention is not limited to this specific embodiment thereof, but can be subjected to various modifications and alterations within the scope of the invention described in the claims.

What is claimed is:

1. A control apparatus for a Stirling engine that uses exhaust gas of an internal combustion engine as a high-temperature heat source and is provided with a starter that drives an output shaft, comprising:
a control unit that drives the starter in starting up the Stirling engine, stops driving the starter when a rotational speed of the Stirling engine reaches a target rotational speed, and then drives the starter again when the rotational speed of the Stirling engine becomes lower than a predetermined value.

2. The control apparatus according to claim 1, wherein the control unit adjusts the driving of the starter in accordance with a degree of change in a temperature of a working fluid for the Stirling engine.

3. The control apparatus according to claim 2, wherein the control unit adjusts the driving of the starter such that a degree of rise in the rotational speed of the Stirling engine increases as the degree of change in the temperature of the working fluid increases.

4. The control apparatus according to claim 1, further comprising:
a first estimation unit that estimates a generation rotational speed of the Stirling engine on a basis of an operation state of the internal combustion engine, and
a setting unit that sets the target rotational speed so that the target rotational speed is equal to or lower than the generation rotational speed.

5. The control apparatus according to claim 4, wherein the generation rotational speed is a maximum output generation rotational speed at which a maximum output is generated.

6. The control apparatus according to claim 1, further comprising:
a second estimation unit that estimates an accumulated value of an exhaust gas energy of the internal combustion engine, wherein in starting up the Stirling engine, the control unit drives the starter when the accumulated value estimated by the second estimation unit is larger than a predetermined value and it is estimated that a minimum output of the Stirling engine that is needed for autonomous operation will be obtained if the starter is driven.

7. The control apparatus according to claim 6, wherein the accumulated value of the exhaust gas energy is an accumulated value of a product of an intake air amount of the internal combustion engine and an exhaust gas temperature of the internal combustion engine.

8. The control apparatus according to claim 6, further comprising
a third estimation unit that estimates an output of the Stirling engine on a basis of an operation state of the internal combustion engine, wherein in a case where the output estimated by the third estimation unit is equal to or larger than a predetermined value, it is estimated that the minimum output of the Stirling engine that is needed for autonomous operation will be obtained if the starter is driven.

9. The control apparatus according to claim 1, further comprising
a third estimation unit that estimates an output of the Stirling engine on a basis of an operation state of the internal combustion engine, wherein the control unit stops driving the starter when the output estimated by the third estimation unit is smaller than a predetermined threshold during deceleration of a vehicle that includes the internal combustion engine.

10. A control method for a Stirling engine that uses exhaust gas of an internal combustion engine as a high-temperature heat source and is provided with a starter that drives an output shaft, comprising:
driving the starter in starting up the Stirling engine;
determining whether or not a rotational speed of the Stirling engine has reached a target rotational speed;
stopping driving the starter when the rotational speed of the Stirling engine has reached the target rotational speed;
determining whether or not the rotational speed of the Stirling engine has become lower than a predetermined value, after stopping driving the starter; and
driving the starter again when the rotational speed of the Stirling engine has become lower than the predetermined value, after stopping driving the starter.
